(19) United States
(12) Patent Application Publication
(10) Pub. No.: US 2025/0349276 A1
(43) Pub. Date: Nov. 13, 2025

(54) GENERATING MUSIC FROM IMAGES USING GENERATIVE NEURAL NETWORKS

(71) Applicant: DeepMind Technologies Limited, London (GB)

(72) Inventors: Timo Immanuel Denk, Zurich (CH); Jesse Engel, Orinda, CA (US); Christian Frank, Zurich (CH)

(21) Appl. No.: 18/662,913

(22) Filed: May 13, 2024

(51) Int. Cl. G10H 7/00; G06N 3/045; G06N 3/0475; G06V 10/82

(52) U.S. Cl. CPC G10H 7/00; G06N 3/045; G06N 3/0475; G06V 10/82; G10H 2250/311

(57) ABSTRACT

Methods, systems, and apparatus, including computer programs encoded on computer storage media, for generating an audio signal. One of the methods includes receiving an input image; processing, using one or more generative neural networks, the input image to generate a music caption describing one or more audio features corresponding to the input image; and processing, using an audio generative neural network, the music caption to generate an audio signal described by the music caption.

### BACKGROUND

This specification relates to generating audio using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates an audio signal that includes music that sounds appropriate for a given image using one or more generative neural networks.

Generally, the output audio signal is an output audio example that includes a sample of an audio wave at each of a sequence of output time steps that span a specified time window. For example, the output time steps can be arranged at regular intervals within the specified time window.

The audio sample at a given output time step can be an amplitude value of the audio wave or an amplitude value that has been compressed, companded, or both. For example, the audio sample can be a raw amplitude value or a mu-law companded representation of the amplitude value.

In general, one innovative aspect of the subject matter described in this specification can be embodied in methods that include the actions of receiving an input image; processing, using one or more generative neural networks, the input image to generate a music caption describing one or more audio features corresponding to the input image; and processing, using an audio generative neural network, the music caption to generate an audio signal described by the music caption.

In some implementations, processing, using one or more generative neural networks, the input image to generate a music caption describing one or more audio features corresponding to the input image comprises: processing, using a first generative neural network, the input image to generate an image caption describing the input image; and processing, using the first generative neural network, a network input comprising at least the image caption to generate a music caption describing one or more audio features.

In some implementations, processing, using a first generative neural network, the input image to generate an image caption describing the input image comprises providing the input image and a request to describe the content of the input image as input to the first generative neural network.

In some implementations, processing, using the first generative neural network, a network input comprising at least the image caption to generate a music caption describing one or more audio features comprises providing the network input and a request to rewrite the image caption into a music caption as input to the first generative neural network.

In some implementations, the request further comprises one or more examples, each comprising an example image caption and a corresponding example music caption.

In some implementations, the network input further comprises the input image, and wherein processing, using the first generative neural network, a network input comprising at least the image caption to generate a music caption describing one or more audio features comprises providing the network input and a request to rewrite the image caption into a music caption for the input image as input to the first generative neural network.

In some implementations, the request further comprises one or more examples, each comprising an example image, a corresponding example image caption, and a corresponding example music caption.

In some implementations, processing, using one or more generative neural networks, the input image to generate a music caption describing one or more audio features corresponding to the input image comprises: processing, using a second generative neural network, the input image to generate an image caption describing the input image; and processing, using a third generative neural network, a network input comprising at least the image caption to generate a music caption describing one or more audio features.

In some implementations, processing, using a second generative neural network, the input image to generate an image caption describing the input image comprises providing the input image and a request to describe the content of the input image as input to the second generative neural network.

In some implementations, processing, using the third generative neural network, a network input comprising at least the image caption to generate a music caption describing one or more audio features comprises providing the network input and a request to rewrite the image caption into a music caption as input to the third generative neural network.

In some implementations, the request further comprises one or more examples, each comprising an example image caption and a corresponding example music caption.

In some implementations, the audio generative neural network is configured to generate an audio signal conditioned on at least text.

In some implementations, receiving an input image comprises receiving the input image from a user.

In some implementations, the method further comprises providing the audio signal for presentation to a user.

In some implementations, the one or more audio features describe any one or more of: style, rhythm, timing, tone, mood, or instruments.

Other embodiments of this aspect include corresponding computer systems, apparatus, and computer programs recorded on one or more computer storage devices, each configured to perform the actions of the methods.

Particular embodiments of the subject matter described in this specification can be implemented so as to realize one or more of the following advantages.

The system described in this specification provides for high-quality music generation that sounds appropriate for a given image. For example, for an image that depicts a swan on a calm lake, the system can generate music in a classical style. For an image that depicts a bustling street in the downtown area of a large city, the system can generate music that is more intense, fast, and hectic.

To generate music from an input image, the system can process the image using one or more generative neural networks to generate a music caption. The music caption describes one or more audio features corresponding to the image. The system can process the music caption using an audio generative neural network to generate an audio signal described by the music caption. Thus, the system can use information from the music caption to generate music appropriate for the image. By generating a music caption that describes audio features corresponding to the image, the system can provide the audio generative neural network with a music caption that is descriptive of audio features, resulting in music that adheres to the audio features of the music caption. The music caption has detail specific to audio features that the system can use to generate high-quality and diverse music. The system can thus use the music caption to generate music of higher quality than music generated by, for example, generating music using an aligned embedding space for image and audio, or by providing the audio generative neural network with an image caption.

Conventional systems that generate audio appropriate for a given image may require alignment of embedding spaces for image and audio, which may require large amounts of resources for training and for obtaining the parallel training data to align the embedding spaces. The system described in this specification can generate music appropriate for a given image using pre-trained generative neural networks.

The system can also use few-shot prompting to improve the performance of the generative neural networks without having to further train the generative neural networks.

The system described in this specification can be used to provide different user experiences for interacting with visual content such as visual art. For example, the system can generate music that evokes the same atmosphere, tone, and/or mood of a given artwork, allowing a user to experience the artwork aurally in addition to, or instead of, visually. The system can thus enable users such as visually-impaired users to experience the visual content.

In addition, the system described in this specification can be used to generate suitable music for a video such as a scene from a film, or for a still image from the film scene. For example, the system can generate a music caption for a frame of the film scene. The system can process the music caption to generate an audio signal described by the music caption. The system can thus enable users to add suitable music to a video without having to manually compose, search for, or create the music, which can be difficult or impractical for some users.

The system can also generate music suitable for the video more quickly than manually composing, searching for, or creating the music, allowing users to easily experience different pieces of generated music paired with the video, and to use the generated music as inspiration during the creative process. The system can thus provide for a more efficient user experience for the film creation process.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example audio generation system.

FIG. 2 is a block diagram of another example audio generation system.

FIG. 3 is a block diagram of another example audio generation system.

FIG. 4 shows example few-shot prompt examples.

FIG. 5 shows example images and music captions.

FIG. 6 is a flow diagram of an example process for generating an audio signal given an image.

Like reference numbers and designations in the various drawings indicate like elements.

### DETAILED DESCRIPTION

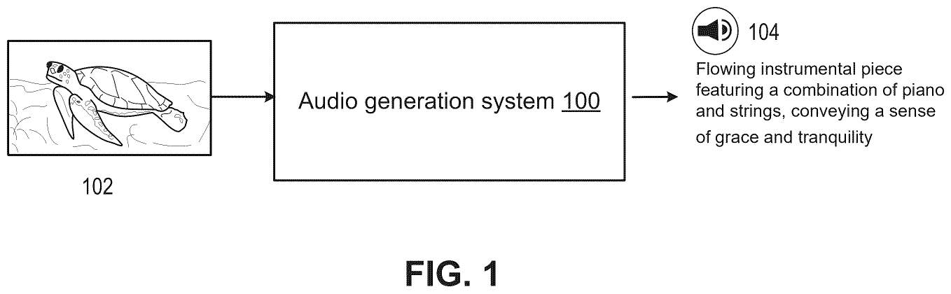

FIG. 1 is a block diagram of an example audio generation system 100. The audio generation system 100 is an example of a system implemented as computer programs on one or more computers in one or more locations in which the systems, components, and techniques described below are implemented.

The audio generation system 100 generates a prediction of an audio signal 104 given an input image 102. The audio signal 104 includes a respective audio sample at each of multiple output time steps spanning a time window. The audio signal 104 includes music that is appropriate for, or reflects, the input image 102.

To generate audio, the system 100 receives the input image 102. The input image 102 includes multiple pixels that each have one or more intensity values, e.g., that includes RGB color values or other color values in another colorization scheme for each pixel of the image. The input image 102 can be a real-world image or a synthetically generated image. In some examples, the input image 102 can depict a physical work of art. In the example of FIG. 1, the input image 102 depicts a turtle in the ocean.

In some examples, the system 100 receives the input image 102 from a user. For example, the system 100 can receive the input image 102 from a user through a user interface of a user device.

The system 100 processes the input image 102, e.g., processes the intensity values of the pixels of the input image 102, to generate a music caption that describes one or more audio features corresponding to the input image 102. The music caption includes a natural language text sequence that describes the one or more audio features. For example, the audio features can include style, rhythm, melody, timing, tone, mood, and/or instruments that are appropriate for the content and/or the atmosphere of the input image 102.

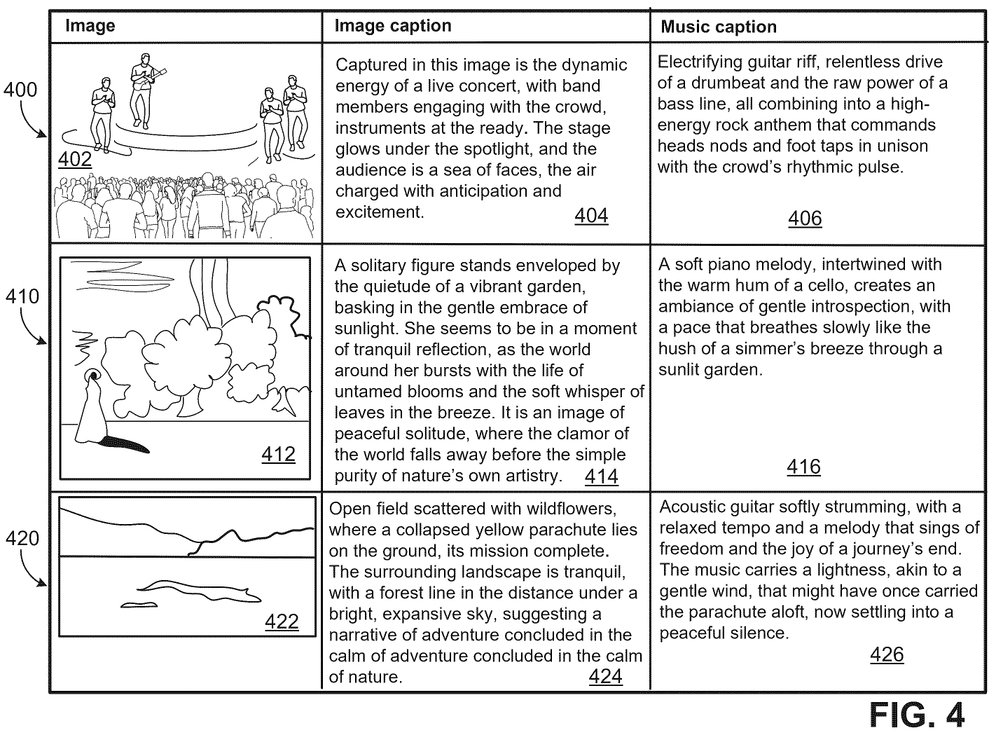

In the example of FIG. 1, the music caption for the input image 102 includes “Flowing instrumental piece featuring a combination of piano and strings, conveying a sense of grace and tranquility.” Some examples of music captions and input images are described below with reference to FIG. 4.

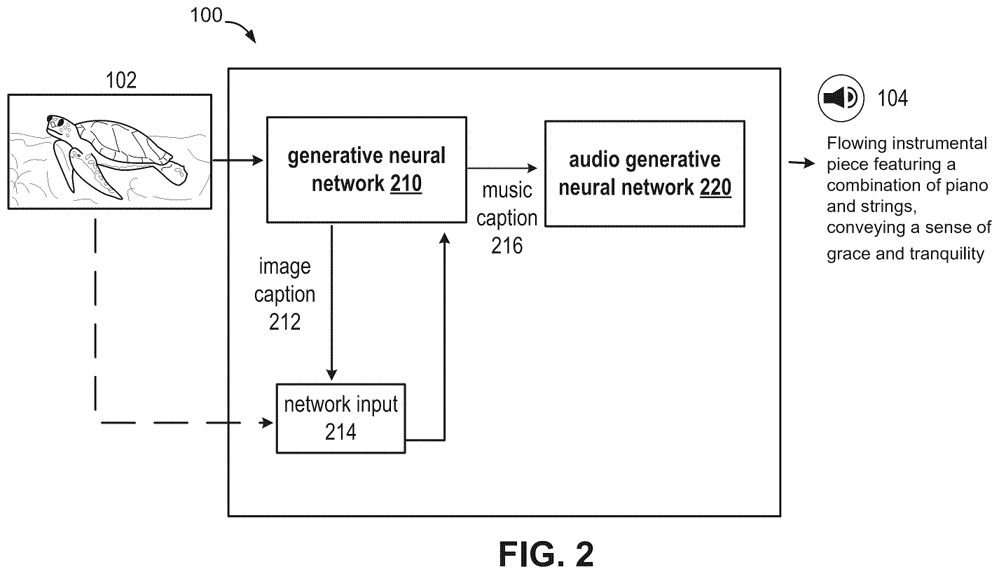

In some implementations, the system 100 can process the input image to generate a music caption using one generative neural network, as described below with reference to FIG. 2.

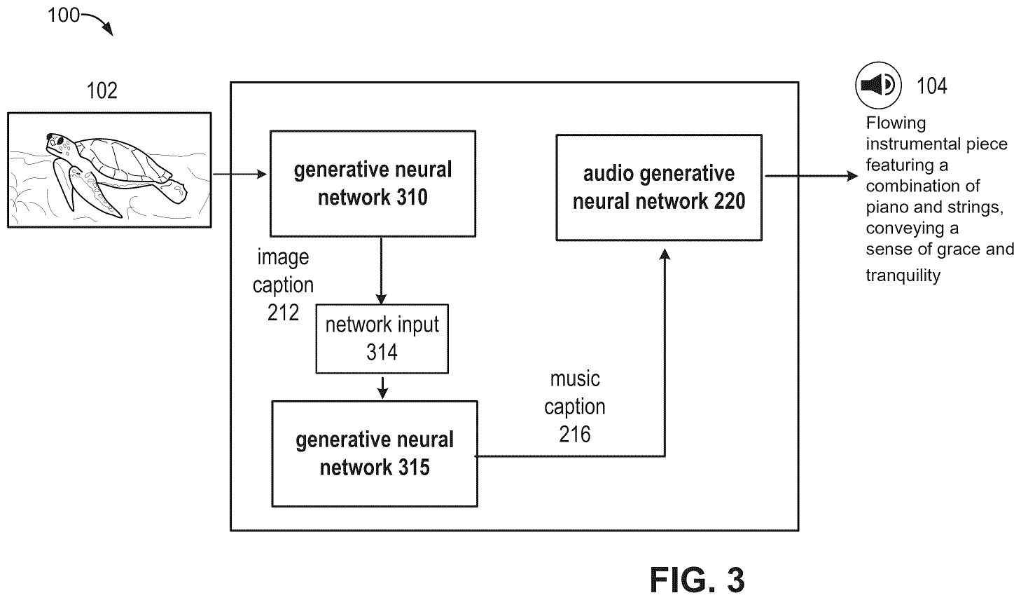

In some other implementations, the system 100 can process the input image to generate a music caption using more than one generative neural network, as described below with reference to FIG. 3.

The system 100 processes at least the music caption to generate the audio signal 104 described by the music caption. The audio signal 104 includes music that can be described by the music caption, as a “flowing instrumental piece featuring a combination of piano and strings, conveying a sense of grace and tranquility.” Because the music caption describes audio features corresponding to the input image 102, the audio signal 104 thus includes music that is appropriate for the input image 102.

For example, the system 100 can use an audio generative neural network to generate the audio signal 104. The audio generative neural network is configured to generate an audio signal conditioned on at least text. An example audio generative neural network is described in further detail below with reference to FIG. 2.

In some examples, the system 100 provides the audio signal 104 for presentation to the user. For example, the system 100 can provide data representing the audio signal 104 to the user device and cause playback of the audio signal 104. The system 100 can thus allow the user to experience the image 102 aurally, providing for a different user experience for interacting with the image 102.

In some examples, the system 100 provides the audio signal 104 for presentation to the user while the image 102 is presented to the user. The system 100 can thus allow the user to simultaneously experience the image 102 visually and aurally, providing for an enhanced user experience for interacting with the image 102 compared to the user experience of only viewing the image 102.

FIG. 2 is a block diagram of the example audio generation system 100 described with reference to FIG. 1. In particular, the audio generation system 100 generates a prediction of the audio signal 104 given the input image 102 using a generative neural network 210 and an audio generative neural network 220.

The system receives the input image 102 as described above with reference to FIG. 1.

The system processes the input image 102 using the generative neural network 210, also referred to as the first generative neural network, to generate an image caption 212. The image caption 212 is a natural language text sequence that describes the input image 102. For example, the image caption 212 describes the content of the input image 102, such as description of visual details, subjects, backgrounds, settings, mood, tone, and/or atmosphere.

To generate the image caption 212, the system 100 can provide the input image 102 and a request to describe the content of the input image as input to the generative neural network 210. For example, the request can include a natural language request to describe what can be seen in the input image. In some examples, the request can include a request to describe what can be seen in the input image with as much detail as possible. In some examples, the request can also specify types of features that an image caption can describe. The generative neural network 210 is described in further detail below.

As an example, the image caption 212 can include “A sea turtle floats calmly in clear turquoise ocean waters near the ocean floor. The ocean floor is teeming with marine life such as fish and plants. The sea turtle seems at peace with its surroundings.”

In some examples, the request to describe what can be seen in the input image includes one or more examples as few-shot prompt examples. For example, the request can include a request to describe what can be seen in the input image according to the examples. In some examples, the request can include a natural language request to describe what can be seen in the input image according to the examples. Each of the examples can include an example image and a corresponding example image caption. Example images and image captions are described below with reference to FIG. 4.

The system 100 includes the image caption 212 in a network input 214. The system 100 processes the network input 214 using the generative neural network 210 to generate a music caption 216.

To generate the music caption 216, the system 100 can provide the network input 214 and a request to rewrite the image caption into a music caption as input to the generative neural network 210. For example, the request can include a natural language request to describe how a suitable musical accompaniment for the image caption would sound. In some examples, the natural language request can also include a definition of a music caption, for example, that includes the types of audio features that a music caption can describe. The generative neural network 210 is described in further detail below.

The music caption 216 is an example of the music caption described above with reference to FIG. 1 and describes one or more audio features corresponding to the input image 102. For example, the audio features can include style, rhythm, melody, timing, tone, mood, and/or instruments.

In the example of FIG. 2, the music caption 216 includes “Flowing instrumental piece featuring a combination of piano and strings, conveying a sense of grace and tranquility.” The music caption 216 describes features such as instruments, style, and mood.

In some examples, the request to rewrite the image caption into a music caption includes one or more examples as few-shot prompt examples. For example, the request can include a request to rewrite the image caption into a music caption according to the examples. In some examples, the request can include a natural language request to rewrite the image caption into a music caption according to the examples. Each of the examples can include an example image caption and a corresponding example music caption. Example image captions and music captions are described below with reference to FIG. 4.

In some examples, the system 100 also includes the input image 102 in the network input 214. In these examples, to generate the music caption 216, the system 100 can provide the network input 214 and a request to rewrite the image caption into a music caption for the input image as input to the generative neural network 210. For example, the request can include a natural language request to describe how a suitable musical accompaniment for the image caption for the image would sound. In some examples, the natural language request can also include a definition of a music caption, for example, that includes the types of audio features that a music caption can describe.

In some examples, the request also includes one or more examples as few-shot prompt examples. For example, the request can include a request to rewrite the image caption into a music caption according to the examples. In some examples, the request can include a natural language request to rewrite the image caption into a music caption according to the examples. Each of the examples can include an example image, a corresponding example image caption, and a corresponding example music caption. Example images, image captions, and music captions are described below with reference to FIG. 4.

The system 100 processes the music caption 216 using the audio generative neural network 220 to generate the audio signal 104. The audio generative neural network 220 is configured to perform text-conditioned music generation so that the generated audio is music that is described by the input text data. The audio signal 104 thus includes music that can be described as a “flowing instrumental piece featuring a combination of piano and strings, conveying a sense of grace and tranquility.” An example audio generative neural network 220 is described further below.

The generative neural network 210 is configured to perform machine learning tasks that involve operating on an input and/or generating an output, such as image processing tasks and/or text processing tasks. As an example, an image processing task to be performed may be specified by the words in the natural or computer language.

For example, if the input includes the input image 102 and a request to describe the content of the input image 102, the output includes text that describes the content of the input image. If the input includes the image caption 212 and a request to rewrite the image caption into a music caption, the output includes text that describes audio features corresponding to the image caption. If the input includes the image caption 212, the input image 102, and a request to rewrite the image caption into a music caption for the input image, the output includes text that describes audio features corresponding to the image caption and the input image.

The generative neural network 210 processes a sequence of input data elements, e.g., image embeddings and/or text tokens, derived from the input image data and/or input text to generate an output that includes text. An “embedding” as used in this specification is a sequence of one or more vectors of numeric values, e.g., floating point values or other values, each vector having a pre-determined dimensionality. For example, the generative neural network 210 can process the sequence of input data elements using a language model neural network to generate the output.

The language model neural network can have any appropriate architecture for processing text and/or images. The language model neural network can have any appropriate Transformer-based architecture, e.g., an encoder-only Transformer architecture, an encoder-decoder Transformer architecture, a decoder-only Transformer architecture, or another attention-based architecture, that includes one or more attention layers.

In general a Transformer-based architecture can be one which is characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used.

As an example, the generative neural network 210 can include a visual language model neural network. A visual language model neural network can be trained using very large (but possibly noisy) datasets in which text is paired with an image and/or with one or more other types of data, e.g., audio data, or data relating to the operation of an agent acting in an environment to perform a variety of tasks. Such a model can be trained, e.g., using self-supervised learning. The pairing can often be imperfect, and the training dataset can, but may not, include any actual examples of a particular task to be performed, but nonetheless an ability to perform a particular task can emerge. There are many examples of suitable, publicly available training datasets.

Some example generative neural networks with which the techniques described herein may be used include: Flamingo (Alayrac et al., arXiv:2204.14198); ALIGN (Jia et al., arXiv:2102.05918); PaLI (Chen et al., arXiv:2209.06794) and PaLI-X (Chen et al., arXiv:2305.18565); and Gemini (“Gemini: A Family of Highly Capable Multimodal Models, Gemini Team, Google”). These references also include indications of training datasets that may be used to train the respective models.

As a particular example, the visual language model neural network can include token processing layers. The token processing layers may constitute a language model neural network, trained on a large database of data, e.g., natural language data, such that upon an input token string (e.g., that represents the input text and includes a sequence of text tokens from a vocabulary) being input to the first token processing layer, the output token string is an appropriate response. The visual language model neural network can also include gated cross-attention layers interleaved with the token processing layers. The gated cross-attention layers can apply an attention function over image embeddings for the input image(s) and the input token string. In some examples, the input token string can also include “markers” (one or more tokens, e.g., tokens contained in the same vocabulary as the input token string) indicating the existence and optionally location of the input image(s).

As used herein an image may be any still or moving image, i.e., the image may be part of a video, in 2D or 3d, and may be a monochrome, color or hyperspectral image, i.e., comprising monochrome or color pixels. As defined herein an “image” includes a point cloud, e.g., from a LIDAR system, and a “pixel” includes a point of the point cloud. The image, during or after (pre-) training and/or fine tuning may, e.g., have been captured by a camera or other image sensor from the real world, and objects in the image or video may comprise physical objects, represented by the image or video.

In general, performing an image processing task using a visual language model (VLM) neural network, that includes an (a trained) image encoder neural network, can involve providing an image to the image encoder neural network to generate a representation of the image, in particular of features of the image. The representation of the image is then processed to perform the image processing task. In general techniques for processing image representations to perform a wide range of image processing tasks are well known.

For example, the system 100 can generate a representation of the image as a sequence of one or more embeddings. The system 100 can divide the image into a sequence of patches (i.e., spatial regions) and generate a respective embedding of each patch using an image encoder neural network. The system can then concatenate the respective embeddings of the image patches to generate a representation of the image as a sequence of embeddings.

In one example, the image encoder neural network can have a residual neural network architecture including a sequence of residual blocks, e.g., where the input to each residual block is added to the output of the residual block. As another example, the image encoder neural network can have a convolutional neural network architecture that includes one or more convolutional layers. As another example, the image encoder neural network can have an attention-based neural network architecture. For instance, the encoder neural network can include one or more self-attention neural network layers. The encoder neural network can repeatedly update initial embeddings of the image patches, e.g., using self-attention neural network layers, to generate a respective final embedding of each image patch. In a particular example, the encoder neural network can have a Vision Transformer architecture, e.g., as described with reference to: A. Dosovitskiy et al., “An image is worth 16×16 words: transformers for image recognition at scale,” arXiv:2010.11929v2, 2021.

Text may be received, e.g., as a series of encoded characters, e.g., UTF-8 encoded characters; such “characters” can include Chinese and other similar characters, as well as logograms, syllabograms and the like. The system can use a text encoder to represent the input text as a sequence of text tokens from a vocabulary of text tokens. The set of text tokens can include, e.g., characters, n-grams, word pieces, words, or a combination thereof. In some examples, the system can map each text token to a corresponding numerical value in accordance with a predefined mapping. In some examples, the system can represent each text token by a corresponding embedding, e.g., in accordance with a predefined mapping from numerical values to embeddings.

An example audio generative neural network 220 is now described. For example, the audio generative neural network 220 can be configured to generate an audio signal using one or more generative neural networks.

For example, the system can provide a request to generate an audio signal having a respective audio sample at each of multiple output time steps spanning a time window conditioned on an input to the audio generative neural network 220.

The input can include, for example, text data that includes the music caption 216.

The audio generative neural network 220 processes the input using an embedding neural network to map the input to one or more embedding tokens. For example, the embedding neural network can be trained to map text and audio to a joint embedding space of text and audio, also referred to as a joint audio embedding space. The audio generative neural network 220 can generate an embedding vector for the input of text data in a joint embedding space using the embedding neural network. The audio generative neural network 220 can then quantize the embedding vector to generate embedding tokens.

For example, the embedding neural network can include a neural network that maps text inputs to embeddings, and a neural network that maps audio inputs to embeddings. In the joint embedding space of text and audio, both text and audio are mapped to embeddings in the same embedding space. That is, the embedding vectors for text and audio have the same dimensionality. Furthermore, embeddings that are close together in the joint embedding space signify that the embeddings share semantics within and across modalities. For example, two embeddings that are close to each other can represent two text sequences that are semantically similar, two audio samples that are semantically similar, or an audio sample and a text sequence with semantically similar features. As an example, the embedding neural network can be a MuLan model.

The audio generative neural network 220 generates a semantic representation of the audio signal 104. The semantic representation specifies a respective semantic token at each of multiple first time steps spanning the time window. Each semantic token is selected from a vocabulary of semantic tokens and represents semantic content of the audio signal 104 at the corresponding first time step. Examples of semantic content that can be represented by the semantic tokens include genre, melody, harmony, and rhythmic properties for music.

The audio generative neural network 220 can generate the semantic representation auto-regressively using a semantic representation generative neural network with embedding tokens as a conditioning signal. For example, the semantic representation generative neural network can be conditioned on the embedding tokens while auto-regressively generating the semantic representation. That is, the semantic token at each first time step can be conditioned on the semantic tokens for preceding first time steps and the embedding tokens. The semantic representation generative neural network can generate Sₜ|S_{<t}, M_{T} where Sₜ represents a semantic token at a first time step t, and M_{T} represents the embedding tokens. For example, the semantic representation generative neural network can have been trained to predict semantic representations generated based on outputs of one or more layers, e.g., of one of the intermediate layers, of an audio representation neural network.

The audio representation neural network can have been trained to generate representations of input audio signals. The audio representation neural network can be a w2v-BERT model that maps input audio signals to a set of linguistic features, for example.

The audio generative neural network 220 then generates, using one or more generative neural networks and conditioned on at least the semantic representation, an acoustic representation of the audio signal 104. The acoustic representation specifies a set of one or more respective acoustic tokens at each of multiple second time steps spanning the time window. The one or more respective acoustic tokens at each second time step represent acoustic properties of the audio signal 104 at the corresponding second time step. Acoustic properties capture the details of an audio waveform and allow for high-quality synthesis. Acoustic properties can include, for example, recording conditions such as level of reverberation, distortion, and background noise.

For example, the audio generative neural network 220 can generate acoustic tokens for the acoustic representation using a coarse generative neural network and a fine generative neural network. The coarse generative neural network and the fine generative neural network can be trained to predict acoustic representations generated based on outputs of an encoder neural network by processing the audio signal.

For example, the encoder neural network can be a convolutional encoder that maps the audio signal to a sequence of embeddings. Each respective embedding at each of multiple second time steps can correspond to features of the audio signal at the second time step. The ground truth acoustic representation for an audio signal can be generated by applying quantization to each of the respective embeddings. For example, the encoder neural network can be part of a neural audio codec such as a Soundstream neural audio codec. For example, the quantization can be residual vector quantization that encodes each embedding using a hierarchy of multiple vector quantizers that each generate a respective acoustic token from a corresponding vocabulary of acoustic tokens for the vector quantizer.

The set of one or more respective acoustic tokens at each of the multiple second time steps includes multiple acoustic tokens that collectively represent a prediction of an output of a residual vector quantization applied to an embedding that represents acoustic properties of the audio signal at the second time step. The residual vector quantization encodes the embedding using a hierarchy of multiple vector quantizers that each generate a respective acoustic token from a corresponding vocabulary of acoustic tokens for the vector quantizer. The hierarchy includes one or more coarse vector quantizers at one or more first positions in the hierarchy and one or more fine vector quantizers at one or more last positions in the hierarchy. The set of acoustic tokens at each second time step thus includes, for each vector quantizer, a respective acoustic token selected from the vocabulary for the vector quantizer.

For example, the hierarchy can include coarse vector quantizers and fine vector quantizers.

To generate the acoustic representation, the coarse generative neural network can generate acoustic tokens for coarse vector quantizers conditioned on at least the semantic representation and the embedding tokens. For example, the coarse generative neural network can generate, for each of the one or more coarse vector quantizers in the hierarchy, the respective acoustic tokens for the second time steps for the vector quantizer conditioned on at least the semantic representation and the embedding tokens.

The coarse generative neural network can be an auto-regressive neural network that is configured to generate the acoustic tokens for coarse vector quantizers auto-regressively according to a first generation order. In some implementations, the coarse generative neural network has a decoder-only Transformer architecture. In some implementations, the coarse generative neural network has an encoder-decoder Transformer architecture.

To generate the acoustic representation, the fine generative neural network can generate acoustic tokens for fine vector quantizers conditioned on at least the acoustic tokens for coarse vector quantizers and the embedding tokens. For example, the fine generative neural network can generate, for each of the one or more fine vector quantizers in the hierarchy, the respective acoustic tokens for the second time steps for the vector quantizer conditioned on the respective acoustic tokens for the second time steps for the one or more coarse vector quantizers in the hierarchy.

The fine generative neural network can be an auto-regressive neural network that is configured to generate the acoustic tokens auto-regressively according to a second generation order. In some implementations, the fine generative neural network has a decoder-only Transformer architecture. In some implementations, the fine generative neural network has an encoder-decoder Transformer architecture.

The audio generative neural network 220 then processes at least the acoustic representation using a decoder neural network to generate the prediction of the audio signal 104. For example, the respective audio sample at each of multiple output time steps spanning the time window can be based on one or more acoustic tokens of the acoustic representation.

In some implementations, the decoder neural network can be a decoder neural network of a neural audio codec. The neural audio codec can be a SoundStream neural audio codec, for example.

The neural audio codec can include a decoder neural network and an encoder neural network. For example, the encoder neural network can convert audio into a coded signal which is quantized into an acoustic representation. The decoder neural network can convert the acoustic representation into a predicted audio signal.

FIG. 3 is a block diagram of the example audio generation system 100 described with reference to FIG. 1. In particular, the audio generation system 100 generates a prediction of the audio signal 104 given the input image 102 using a generative neural network 310, a generative neural network 315, and the audio generative neural network 220.

The system receives the input image 102 as described above with reference to FIG. 1.

The system processes the input image 102 using the generative neural network 310, also referred to as the second generative neural network, to generate the image caption 212. As described above with reference to FIG. 2, the image caption 212 is a natural language text sequence that describes the input image 102.

To generate the image caption 212, the system 100 can provide the input image 102 and a request to describe the content of the input image as input to the generative neural network 310. For example, the request can include a natural language request to describe what can be seen in the input image. In some examples, the request can include a request to describe what can be seen in the input image with as much detail as possible. In some examples, the request can also specify types of features that an image caption can describe. The generative neural network 310 is similar to or the same as the generative neural network 210 described above with reference to FIG. 2.

As an example, the image caption 212 can include “A sea turtle floats calmly in clear turquoise ocean waters near the ocean floor. The ocean floor is teeming with marine life such as fish and plants. The sea turtle seems at peace with its surroundings.”

In some examples, the request to describe what can be seen in the input image includes one or more examples as few-shot prompt examples. For example, the request can include a request to describe what can be seen in the input image according to the examples. In some examples, the request can include a natural language request to describe what can be seen in the input image according to the examples. Each of the examples can include an example image and a corresponding example image caption. Example images and image captions are described below with reference to FIG. 4.

The system 100 includes the image caption 212 in a network input 314. The system 100 processes the network input 314 using the generative neural network 315, also referred to as the third generative neural network, to generate a music caption 216.

To generate the music caption 216, the system 100 can provide the network input 314 and a request to rewrite the image caption into a music caption as input to the generative neural network 315. For example, the request can include a natural language request to describe how a suitable musical accompaniment for the image caption would sound. In some examples, the natural language request can also include a definition of a music caption, for example, that specifies the types of audio features that a music caption can describe. The generative neural network 315 is described in further detail below. In some examples, the generative neural network 310 may be configured to perform image and text processing tasks, but not text-only processing tasks. The system can thus use the generative neural network 315 to perform the text-only processing task of rewriting the image caption into a music caption. In some other examples, although the generative neural network 310 may be configured to perform text-only processing tasks, the system can use the generative neural network 315 to reduce the amount of computing resources and time required to generate the music caption 216. For example, the generative neural network 315 can be smaller, i.e., has fewer weights, than the generative neural network 310.

The music caption 216, as described above with reference to FIG. 2, describes one or more audio features corresponding to, or suitable for, the input image 102. In the example of FIG. 3, the music caption 216 includes “Flowing instrumental piece featuring a combination of piano and strings, conveying a sense of grace and tranquility.”

In some examples, the request to rewrite the image caption into a music caption includes one or more examples as few-shot prompt examples. For example, the request can include a request to rewrite the image caption into a music caption according to the examples. In some examples, the request can include a natural language request to rewrite the image caption into a music caption according to the examples. Each of the examples can include an example image caption and a corresponding example music caption. Example image captions and music captions are described below with reference to FIG. 4.

The system 100 processes the music caption 216 using the audio generative neural network 220 to generate the audio signal 104. The audio generative neural network 220 is described above with reference to FIG. 2. The audio signal 104 thus includes music that can be described as a “flowing instrumental piece featuring a combination of piano and strings, conveying a sense of grace and tranquility.”

The generative neural network 315 is configured to perform text processing tasks. The generative neural network 315 processes input text to generate an output. For example, if the input includes the image caption 212 and a request to rewrite the image caption into a music caption, the output includes text that describes audio features corresponding to the image caption.

The generative neural network 315 can have any appropriate neural network architecture that allows the model to map an input sequence of text tokens from a vocabulary to an output sequence of text tokens from the vocabulary. The generative neural network 315 can have any appropriate Transformer-based architecture, e.g., an encoder-decoder Transformer architecture, or a decoder-only Transformer architecture.

In particular, the generative neural network 315 can be an auto-regressive neural network that auto-regressively generates the output sequence of text tokens by generating each particular text token in the output sequence conditioned on a current input sequence that includes (i) the input sequence followed by (ii) any text tokens that precede the particular text token in the output sequence.

More specifically, to generate a particular text token, the generative neural network 315 can process the current input sequence to generate a score distribution, e.g., a probability distribution, that assigns a respective score, e.g., a respective probability, to each token in the vocabulary of text tokens. The generative neural network 315 can then select, as the particular text token, a text token from the vocabulary using the score distribution. For example, the generative neural network 315 can greedily select the highest-scoring token or can sample, e.g., using top-k sampling, nucleus sampling or another sampling technique, a token from the distribution.

As a particular example, the generative neural network 315 can be an auto-regressive Transformer-based neural network that includes a plurality of layers that each apply a self-attention operation. The generative neural network 315 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv:2005.14165, 2020.

The tokens in the vocabulary can be any appropriate text tokens, e.g., words, word pieces, punctuation marks, characters, bytes, and so on that represent elements of text in one or more natural languages and, optionally, numbers and other text symbols that are found in a corpus of text. For example, the system 100 can tokenize a given sequence of words by applying a tokenizer, e.g., the SentencePiece tokenizer (Kudo et al., arXiv:1808.06226) or another tokenizer, to divide the sequence into tokens from the vocabulary.

Prior to using the generative neural network 315 to generate music captions 216, the generative neural network 315 is pre-trained, e.g., by the system 100 or by one or more other systems.

In particular, the system 100 or the other system(s) pre-trains the generative neural network 315 on a language modeling task, e.g., a task that requires predicting, given a current sequence of text tokens, the next token that follows the current sequence in the training data. Equivalently, the language modeling task can require, for each given unlabeled text sequence in a training data set, predicting a text sequence that followed the given unlabeled text sequence in a corresponding document. As a particular example, the generative neural network 315 can be pre-trained on a maximum-likelihood objective on a large dataset of text, e.g., text that is publicly available from the Internet or another text corpus.

FIG. 4 shows example few-shot prompt examples 400, 410, and 420. Each example includes an image, a corresponding image caption, and a corresponding music caption. Each image caption can include visual details, subjects, backgrounds, settings, mood, tone, and/or atmosphere. Each music caption describes one or more audio features such as style, rhythm, melody, timing, tone, mood, and/or instruments.

The image 402 of the example 400 is a real-world image depicting a concert. The corresponding image caption 404 includes: “Captured in this image is the dynamic energy of a live concert, with band members engaging with the crowd, instruments at the ready. The stage glows under the spotlight, and the audience is a sea of faces, the air charged with anticipation and excitement.” The music caption 406 includes: “Electrifying guitar riff, relentless drive of a drumbeat and the raw power of a bass line, all combining into a high-energy rock anthem that commands head nods and foot taps in unison with the crowd's rhythmic pulse.”

The image caption 404 describes subjects such as “band members engaging with the crowd, instruments at the ready,” and “the audience is a sea of faces.” The image caption 404 also describes settings such as “live concert” and “stage.” The image caption 404 also describes mood and atmosphere such as “dynamic energy,” and “the air charged with anticipation and excitement.” The image caption 404 also describes visual details such as “[t]he stage glows under the spotlight.”

In some examples, the image captions can have different amounts of detail for the same image. For example, an alternative image caption for the image 402 can include “dynamic energy of a live concert, band members engaging with the crowd, instruments at the ready.” Another alternative image caption for the image 402 can include “Live metal concert with electric guitars and huge crowd.” The system can use image captions with different amounts of detail in few-shot prompt examples to influence the generation of potentially different image captions, and thus potentially different music captions and music. The system can also use image captions with fewer details or of shorter length in few-shot prompt examples to enable the use of smaller generative neural networks, which requires fewer computing resources, while maintaining the response time of a larger generative neural network.

The music caption 406 describes instruments such as “electrifying guitar riff,” “relentless drive of a drumbeat, and “raw power of a bass line.” The music caption 406 also describes the style as “rock anthem.” The music caption 406 also describes the mood and tone as “electrifying,” “relentless drive,” “high-energy,” and “commands head nods and foot taps in unison with the crowd's rhythmic pulse.”

In some examples, the music captions can have different amounts of detail for the same image and/or music caption. For example, an alternative music caption for the example 400 can include “electrifying guitar riff, powerful drums and bass line.” The system can use music captions with different amounts of detail in few-shot prompt examples to influence the generation of potentially different music captions, and thus potentially different music. The system can also use music captions with fewer details or of shorter length in few-shot prompt examples to enable the use of smaller generative neural networks while maintaining the response time of a larger generative neural network.

The image 412 of the example 410 depicts a painting. The corresponding image caption 414 includes: “A solitary figure stands enveloped by the quietude of a vibrant garden, basking in the gentle embrace of sunlight. She seems to be in a moment of tranquil reflection, as the world around her bursts with the life of untamed blooms and the soft whisper of leaves in the breeze. It is an image of peaceful solitude, where the clamor of the world falls away before the simple purity of nature's own artistry.” The music caption 416 includes: “A soft piano melody, intertwined with the warm hum of a cello, creates an ambiance of gentle introspection, with a pace that breathes slowly like the hush of a summer's breeze through a sunlit garden.”

The corresponding image caption 414 describes subjects such as “[a] solitary figure stands enveloped by the quietude of a vibrant garden, basking in the gentle embrace of sunlight. She seems to be in a moment of tranquil reflection.” The image caption 414 also describes settings such as “a vibrant garden,” and “the world around her bursts with the life of untamed blooms and the soft whisper of leaves in the breeze.” The image caption 414 also describes the atmosphere as “an image of peaceful solitude, where the clamor of the world falls away before the simple purity of nature's own artistry.”

The music caption 416 describes instruments such as “[a] soft piano melody, intertwined with the warm hum of a cello.” The music caption 416 also describes timing such as “a pace that breathes slowly like the hush of a summer's breeze through a sunlit garden.” The music caption 416 also describes the mood as “an ambiance of gentle introspection.”

The image 422 of the example 412 is a real-world image depicting a parachute on the ground. The corresponding image caption 424 includes: “Open field scattered with wildflowers, where a collapsed yellow parachute lies on the ground, its mission complete. The surrounding landscape is tranquil, with a forest line in the distance under a bright, expansive sky, suggesting a narrative of adventure concluded in the calm of nature.” The music caption 426 includes: “Acoustic guitar softly strumming, with a relaxed tempo and a melody that sings of freedom and the joy of a journey's end. The music carries a lightness, akin to a gentle wind, that might have once carried the parachute aloft, now settling into a peaceful silence.”

The corresponding image caption 424 describes subjects such as “[o]pen field scattered with wildflowers, where a collapsed yellow parachute lies on the ground, its mission complete.” The image caption 424 also describes settings such as “[t]he surrounding landscape is tranquil, with a forest line in the distance under a bright, expansive sky.” The image caption 424 also describes the atmosphere as “suggesting a narrative of adventure concluded in the calm of nature.”

The music caption 426 describes instruments such as “acoustic guitar softly strumming.” The music caption 426 also describes rhythm such as “a relaxed tempo.” The music caption 426 also describes the melody as “a melody that sings of freedom and the joy of a journey's end.” The music caption 426 also describes the mood as “[t]he music carries a lightness, akin to a gentle wind, that might have once carried the parachute aloft, now settling into a peaceful silence.”

The system 100 described above can use few-shot prompt examples such as the few-shot prompt examples 400, 410, and 420, to generate image captions and music captions that include similar types of detail, levels of detail, and/or writing style.

For example, a system such as the system 100 described above with reference to FIG. 2 can use an image, corresponding image caption, and corresponding music caption as a few-shot prompt example for the generative neural network 210. The system 100 can also use an image caption and corresponding music caption as a few-shot prompt example for the generative neural network 210.

A system such as the system 100 described above with reference to FIG. 3 can use an image and a corresponding image caption as a few-shot prompt example for the generative neural network 310. The system 100 can also use an image caption and a corresponding music caption as a few-shot prompt example for the generative neural network 315.

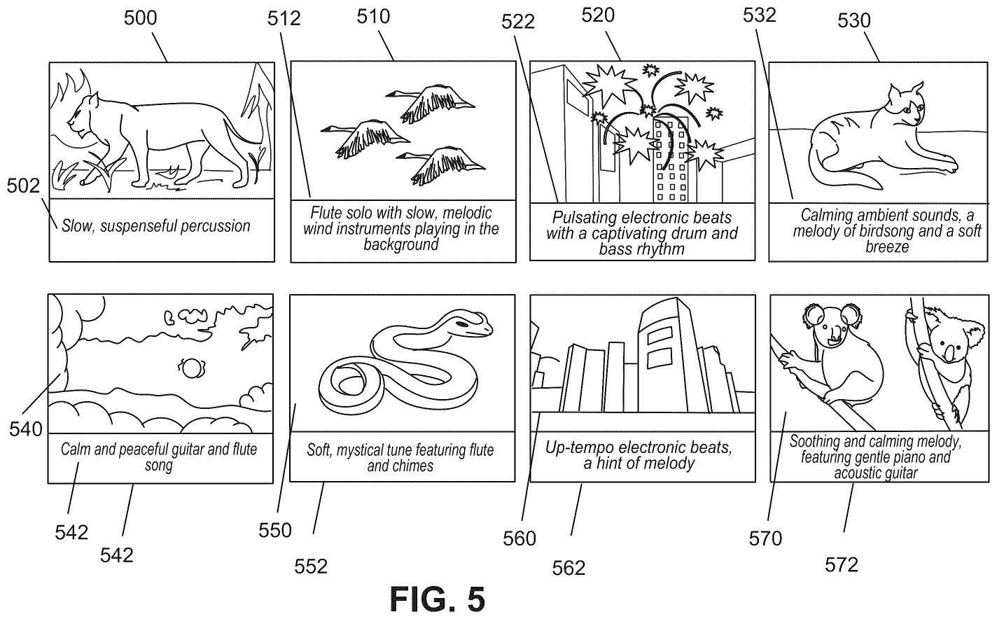

FIG. 5 shows example images 500, 510, 520, 530, 540, 550, 560, and 570, and music captions 512, 522, 532, 542, 552, 562, and 572. The system 100 can generate music described by the music captions 512, 522, 532, 542, 552, 562, and 572 as described above.

The image 500 depicts a tiger walking through grass. An example music caption 502 can describe rhythm, timing, and instruments, and includes “slow, suspenseful percussion.” A piece of music with slow and suspenseful percussion is appropriate for the image 500, reflecting the steps of the tiger depicted in the image 500.

The image 510 depicts birds flying over a lake. An example music caption 512 can describe instruments and timing, and includes “flute solo with slow, melodic wind instruments playing in the background.” A piece of music with a flute solo and slow, melodic wind instruments is appropriate for the image 510, reflecting the relaxed flight of the birds and the calm atmosphere of the image 510.

The image 520 depicts a fireworks show over city skyscrapers. An example music caption 522 can describe instruments, rhythm, and mood, and includes “pulsating electronic beats with a captivating drum and bass rhythm.” A piece of music with pulsating electronic beats with a captivating drum and bass rhythm is appropriate for the image 520, reflecting the celebratory and modern atmosphere of the image 520.

The image 530 depicts a cat lying on a sofa. An example music caption 532 can describe mood and melody, and includes “calming ambient sounds, a melody of birdsong and a soft breeze.” A piece of music with calming ambient sounds and a melody of birdsong and a soft breeze is appropriate for the image 530, reflecting the relaxing atmosphere of the image 530.

The image 540 depicts a sunset over mountains. An example music caption 542 can describe instruments and mood, and includes “calm and peaceful guitar and flute song.” A piece of music with calm and peaceful guitar and flute is appropriate for the image 540, reflecting the calm atmosphere of the image 540.

The image 550 depicts a snake. An example music caption 552 can describe instruments and mood, and includes “soft, mystical tune featuring flute and chimes.” A piece of music with a soft and mystical tune with flute and chimes is appropriate for the image 550, reflecting the quiet atmosphere of the image 550.

The image 560 depicts a busy intersection in a large city. An example music caption 562 can describe instruments, rhythm, and melody, and includes “up-tempo electronic beats, a hint of melody.” A piece of music with up-tempo electronic beats and some melody is appropriate for the image 560, reflecting the busy streets and energetic atmosphere of the image 560.

The image 570 depicts two koalas sleeping in a tree. An example music caption 572 can describe instruments, melody, and mood, and includes “soothing and calming melody, featuring gentle piano and acoustic guitar.” A piece of music with a soothing and calming melody and that features gentle piano and acoustic guitar is appropriate for the image 570, reflecting the sleeping koalas and calm atmosphere of the image 570.

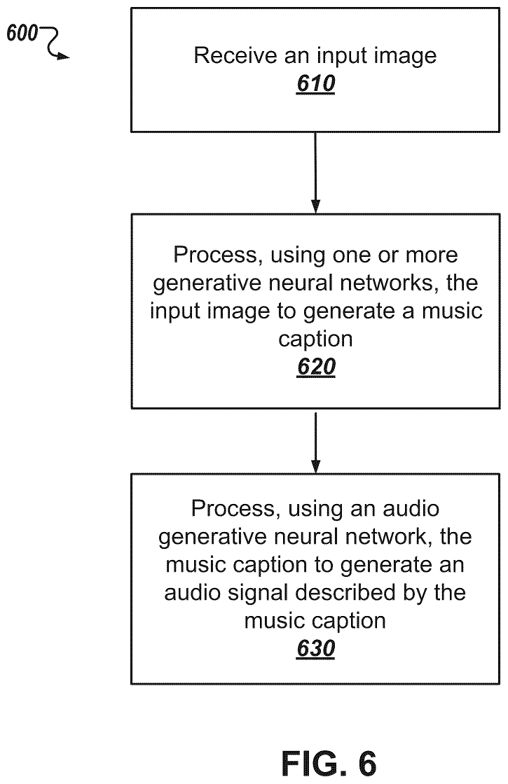

FIG. 6 is a flow diagram of an example process for generating an audio signal given an image. For convenience, the process 600 will be described as being performed by a system of one or more computers located in one or more locations. For example, an audio generation system, e.g., the audio generation system 100 of FIG. 1, FIG. 2, and FIG. 3, appropriately programmed in accordance with this specification, can perform the process 600.

The system receives an input image (step 610). In some examples, the system can receive the input image from a user.

The system processes, using one or more generative neural networks, the input image to generate a music caption (step 620). The music caption describes one or more audio features corresponding to the input image. For example, the music caption can describe style, rhythm, melody, timing, tone, mood, or instruments.

In some implementations, as described above with reference to FIG. 2, the system can process the input image using the generative neural network 210 to generate an image caption describing the input image. The system can process a network input that includes at least the image caption using the same generative neural network 210 to generate the music caption. In some examples, the network input also includes the input image.

In some examples, the system can provide few-shot prompt examples to the generative neural network 210. For example, to generate the music caption, the system can provide the network input and a request to rewrite the image caption into a music caption according to the few-shot prompt examples to the generative neural network 210. Example few-shot prompt examples are described above with reference to FIG. 4.

In some implementations, as described above with reference to FIG. 3, the system can process the input image using the generative neural network 310 to generate an image caption describing the input image. The system can process a network input that includes at least the image caption using a different generative neural network 315 to generate the music caption.

In some examples, the system can provide few-shot prompt examples to the generative neural network 315. For example, to generate the music caption, the system can provide the network input and a request to rewrite the image caption into a music caption according to the few-shot prompt examples to the generative neural network 315. Example few-shot prompt examples are described above with reference to FIG. 4.

The system processes, using an audio generative neural network, the music caption to generate an audio signal described by the music caption (step 630). The audio generative neural network is configured to generate an audio signal conditioned on at least text. An example audio generative neural network is described above with reference to FIG. 2.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving an input image;
processing, using one or more generative neural networks, the input image to generate a music caption describing one or more audio features corresponding to the input image; and
processing, using an audio generative neural network, the music caption to generate an audio signal described by the music caption.

Embodiment 2 is the method of embodiment 1, wherein processing, using one or more generative neural networks, the input image to generate a music caption describing one or more audio features corresponding to the input image comprises:
processing, using a first generative neural network, the input image to generate an image caption describing the input image; and
processing, using the first generative neural network, a network input comprising at least the image caption to generate a music caption describing one or more audio features.

Embodiment 3 is the method of embodiment 2, wherein processing, using a first generative neural network, the input image to generate an image caption describing the input image comprises providing the input image and a request to describe the content of the input image as input to the first generative neural network.

Embodiment 4 is the method of any of embodiments 2-3, wherein processing, using the first generative neural network, a network input comprising at least the image caption to generate a music caption describing one or more audio features comprises providing the network input and a request to rewrite the image caption into a music caption as input to the first generative neural network.

Embodiment 5 is the method of embodiment 4, wherein the request further comprises one or more examples, each comprising an example image caption and a corresponding example music caption.

Embodiment 6 is the method of embodiment 2, wherein the network input further comprises the input image, and wherein processing, using the first generative neural network, a network input comprising at least the image caption to generate a music caption describing one or more audio features comprises providing the network input and a request to rewrite the image caption into a music caption for the input image as input to the first generative neural network.

Embodiment 7 is the method of embodiment 6, wherein the request further comprises one or more examples, each comprising an example image, a corresponding example image caption, and a corresponding example music caption.

Embodiment 8 is the method of any of embodiments 1-7, wherein processing, using one or more generative neural networks, the input image to generate a music caption describing one or more audio features corresponding to the input image comprises:
processing, using a second generative neural network, the input image to generate an image caption describing the input image; and
processing, using a third generative neural network, a network input comprising at least the image caption to generate a music caption describing one or more audio features.

Embodiment 9 is the method of embodiment 8, wherein processing, using a second generative neural network, the input image to generate an image caption describing the input image comprises providing the input image and a request to describe the content of the input image as input to the second generative neural network.

Embodiment 10 is the method of any of embodiments 8-9, wherein processing, using the third generative neural network, a network input comprising at least the image caption to generate a music caption describing one or more audio features comprises providing the network input and a request to rewrite the image caption into a music caption as input to the third generative neural network.

Embodiment 11 is the method of embodiment 10, wherein the request further comprises one or more examples, each comprising an example image caption and a corresponding example music caption.

Embodiment 12 is the method of any of embodiments 1-11, wherein the audio generative neural network is configured to generate an audio signal conditioned on at least text.

Embodiment 13 is the method of any of embodiments 1-12, wherein receiving an input image comprises receiving the input image from a user.

Embodiment 14 is the method of any of embodiments 1-13, wherein the method further comprises providing the audio signal for presentation to a user.

Embodiment 15 is the method of any of embodiments 1-14, wherein the one or more audio features describe any one or more of: style, rhythm, timing, tone, mood, or instruments.

Embodiment 16 is a system comprising:
one or more computers; and
one or more storage devices communicatively coupled to the one or more computers, wherein the one or more storage devices store instructions that, when executed by the one or more computers, cause the one or more computers to perform the method of any one of embodiments 1 to 15.

Embodiment 17 is one or more non-transitory computer-readable storage media storing instructions that when executed by one or more computers cause the one or more computers to perform the method of any one of embodiments 1 to 15.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A computer-implemented method comprising:
receiving an input image;
processing, using one or more generative neural networks, the input image to generate a music caption describing one or more audio features corresponding to the input image; and
processing, using an audio generative neural network, the music caption to generate an audio signal described by the music caption.

2. The method of claim 1, wherein processing, using one or more generative neural networks, the input image to generate a music caption describing one or more audio features corresponding to the input image comprises:
processing, using a first generative neural network, the input image to generate an image caption describing the input image; and
processing, using the first generative neural network, a network input comprising at least the image caption to generate a music caption describing one or more audio features.

3. The method of claim 2, wherein processing, using a first generative neural network, the input image to generate an image caption describing the input image comprises providing the input image and a request to describe the content of the input image as input to the first generative neural network.

4. The method of claim 2, wherein processing, using the first generative neural network, a network input comprising at least the image caption to generate a music caption describing one or more audio features comprises providing the network input and a request to rewrite the image caption into a music caption as input to the first generative neural network.

5. The method of claim 4, wherein the request further comprises one or more examples, each comprising an example image caption and a corresponding example music caption.

6. The method of claim 2, wherein the network input further comprises the input image, and wherein processing, using the first generative neural network, a network input comprising at least the image caption to generate a music caption describing one or more audio features comprises providing the network input and a request to rewrite the image caption into a music caption for the input image as input to the first generative neural network.

7. The method of claim 6, wherein the request further comprises one or more examples, each comprising an example image, a corresponding example image caption, and a corresponding example music caption.

8. The method of claim 1, wherein processing, using one or more generative neural networks, the input image to generate a music caption describing one or more audio features corresponding to the input image comprises:
processing, using a second generative neural network, the input image to generate an image caption describing the input image; and
processing, using a third generative neural network, a network input comprising at least the image caption to generate a music caption describing one or more audio features.

9. The method of claim 8, wherein processing, using a second generative neural network, the input image to generate an image caption describing the input image comprises providing the input image and a request to describe the content of the input image as input to the second generative neural network.

10. The method of claim 8, wherein processing, using the third generative neural network, a network input comprising at least the image caption to generate a music caption describing one or more audio features comprises providing the network input and a request to rewrite the image caption into a music caption as input to the third generative neural network.

11. The method of claim 10, wherein the request further comprises one or more examples, each comprising an example image caption and a corresponding example music caption.

12. The method of claim 1, wherein the audio generative neural network is configured to generate an audio signal conditioned on at least text.

13. The method of claim 1, wherein receiving an input image comprises receiving the input image from a user.

14. The method of claim 1, further comprising providing the audio signal for presentation to a user.

15. The method of claim 1, wherein the one or more audio features describe any one or more of: style, rhythm, timing, tone, mood, or instruments.

16. A system comprising:
one or more computers; and
one or more storage devices communicatively coupled to the one or more computers, wherein the one or more storage devices store instructions that, when executed by the one or more computers, cause the one or more computers to perform operations comprising:
receiving an input image;
processing, using one or more generative neural networks, the input image to generate a music caption describing one or more audio features corresponding to the input image; and
processing, using an audio generative neural network, the music caption to generate an audio signal described by the music caption.

17. The system of claim 16, wherein processing, using one or more generative neural networks, the input image to generate a music caption describing one or more audio features corresponding to the input image comprises:
processing, using a first generative neural network, the input image to generate an image caption describing the input image; and
processing, using the first generative neural network, a network input comprising at least the image caption to generate a music caption describing one or more audio features.

18. The system of claim 17, wherein processing, using a first generative neural network, the input image to generate an image caption describing the input image comprises providing the input image and a request to describe the content of the input image as input to the first generative neural network.

19. The system of claim 17, wherein processing, using the first generative neural network, a network input comprising at least the image caption to generate a music caption describing one or more audio features comprises providing the network input and a request to rewrite the image caption into a music caption as input to the first generative neural network.

20. One or more non-transitory computer storage media storing instructions that when executed by one or more computers cause the one or more computers to perform operations comprising:
receiving an input image;
processing, using one or more generative neural networks, the input image to generate a music caption describing one or more audio features corresponding to the input image; and
processing, using an audio generative neural network, the music caption to generate an audio signal described by the music caption.
